(19) United States
(12) Patent Application Publication
(10) Pub. No.: US 2016/0266947 A1
(43) Pub. Date: Sep. 15, 2016

(54) MOBILE APPLICATION MEMORY PROFILING FOR CUSTOM EXTENSIONS

(71) Applicant: Microsoft Technology Licensing, LLC, Redmond, WA (US)

(72) Inventors: Hemant Gaur, Redmond, WA (US); Suprita Pagad, Bellevue, WA (US); Ramanathan Ananthanarayan Pallassana, Sammamish, WA (US); Indrojit Deb, Sammamish, WA (US)

(21) Appl. No.: 14/819,673

(22) Filed: Aug. 6, 2015

Related U.S. Application Data
(60) Provisional application No. 62/131,512, filed on Mar. 11, 2015.

(51) Int. Cl. G06F 9/54; G06F 11/30; H04M 1/725

(52) U.S. Cl. CPC G06F 9/546; H04M 1/72522; G06F 11/3055; G06F 11/302

(57) ABSTRACT

A mobile device includes a processor and computer-readable memory having instructions stored thereon that, when executed by the processor, provide an application. The application obtains and stores snapshot information regarding consumption of the computer-readable memory of the mobile device, upon the occurrence of one or more predefined conditions.

### CROSS-REFERENCE TO RELATED APPLICATION

The present application is based on and claims the benefit of U.S. provisional patent application Ser. No. 62/131,512, filed Mar. 11, 2015, the content of which is hereby incorporated by reference in its entirety.

### BACKGROUND

Mobile devices are in widespread use and provide an ever-increasing level of functionality. However, mobile devices, in comparison to desktop computers and other non-mobile devices, generally utilize less hardware and run at lower power levels than non-mobile devices. This not only facilitates the miniaturization of the mobile device, but also helps extend battery life.

One of the main limitations of mobile devices is memory. While mobile devices, such as smart phones and tablets, are available with tens of gigabytes of storage, the operating memory of such devices is much smaller. Further, users of mobile devices will often have more than one application running on the mobile device at the same time. Further still, each application running on the mobile device may perform an action or enter a state where the application may consume, even if momentarily, a disproportionate amount of available system operating memory. This can impact the user's experience not only for the application consuming the disproportionate amount of system memory, but also for other applications operating on the mobile device.

The discussion above is merely provided for general background information and is not intended to be used as an aid in determining the scope of the claimed subject matter.

### SUMMARY

A mobile device includes a processor and computer-readable memory having instructions stored thereon that, when executed by the processor, provide an application. The application obtains and stores snapshot information regarding consumption of the computer-readable memory of the mobile device, upon the occurrence of one or more predefined conditions.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a diagrammatic view of a mobile device interacting with a plurality of information sources to generate a mashup (custom extension) in accordance with one embodiment.

FIGS. 2A and 2B are examples of user interfaces on a mobile device in accordance with embodiments described herein.

FIG. 3 is a block diagram of a mobile device having an application with selectable memory profiling in accordance with one embodiment.

FIG. 4 is a diagrammatic view of application flow including acquisition of one or more memory snapshots in accordance with one embodiment.

FIG. 5 is a flow diagram of a method of executing an application to provide memory profiling information in accordance with one embodiment.

FIG. 6 is a diagrammatic view of a mobile device and user interface providing a user selectable interface element and memory information in accordance with one embodiment.

FIG. 7 provides a general block diagram of the components of a mobile device that can execute one or more application in accordance with one embodiment.

FIG. 8 shows one embodiment in which the mobile device is a tablet computer.

FIGS. 9-11 provide additional examples of mobile devices that can be used with embodiments described herein, although others can be used as well.

### DETAILED DESCRIPTION

Mobile applications sometimes have complex needs with respect to communication and hardware resources. In particular, hybrid mobile applications, such as those that obtain information from a plurality of information sources, can have complex needs of integrating with external content and service providers. External or custom content can potentially affect application performance and reliability depending upon external content and specific device-type capabilities. Embodiments described herein generally provide application design and execution features that provide memory consumption details automatically and/or on demand in an application lifecycle. An application lifecycle, as defined herein, extends from the moment in time at which the application is first initiated for execution on a mobile device until the application is closed on the mobile device. During the application lifecycle, many application events, such as form loads, loading one or more resources and/or navigating to one or more resources may occur. In a hybrid application (such as a mashup) predefined checkpoints can be provided that, when encountered during application execution, will cause the application to obtain mobile device memory utilization information. As used herein, a mashup is a single application that uses content from a plurality of sources to create a single view in a graphical interface. Checkpoints include, for example, before loading starts, after loading is complete, navigating away from a resource, et cetera. Additionally, embodiments described herein also provide the capability to a user to selectively load content on demand and observe memory consumption in response to the selected load operation or actual interaction with mashups. Further, at least some mobile operating system platforms may issue warnings and error messages for low memory conditions. These warnings can be captured or otherwise used to invoke a memory snapshot or mashup disabling for further analysis.

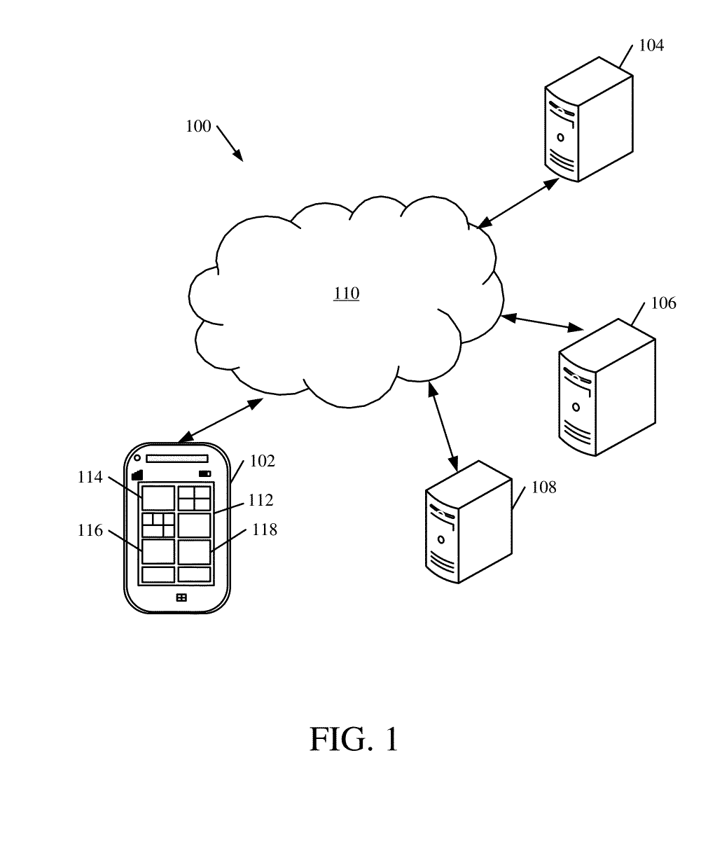

FIG. 1 is a diagrammatic view of an environment in which embodiments described herein are particularly useful. Environment 100 includes mobile device 102 communicatively coupled to information sources 104, 106, 108 via network 110. Network 110 may be any suitable data communication network, such as the internet. One or more of information sources 104, 106, 108 may be a proprietary information source, that requires user authentication, and provides its information via an encrypted communication channel. Other information sources may simply provide information without any user authentication and/or encryption. As illustrated in FIG. 1, mobile device 102 is executing a hybrid application 112 that is displaying information related to sources 104, 106, and 108. In particular, box 114 is providing information related to source 104, while box 116 provides information related to information source 106. Finally, box 118 provides information related to information source 108. In the illustrated mashup application 112, box 118 may be providing information related to source 108 that may allow for the user of device 102 to enter information that will be stored with information source 108. For example, box 118 may be a form, or other suitable user interface element. Additionally, box 114 may be displaying video information, such as a news feed, from information source 104. As can be appreciated, the memory and hardware demands generated by application 112 rendering video in box 114 may be significantly more than the memory requirements of the form rendered in box 118. While this is an exaggerated example, it is intended to illustrate that a mashup application can have various components with vastly different demands on the memory of the mobile device.

In order to identify situations in which the memory of the device becomes constrained, and potentially affects application execution, embodiments provided herein allow a user and/or developer of an application to selectively cause the application to execute in a diagnostic mode. In such diagnostic mode, when the application encounters one or more predefined checkpoints during operation, such checkpoint(s) will trigger acquisition of snapshot information relative to memory of the mobile device. This snapshot information can be provided to the user or developer to view current memory usage, potentially broken down to various pages of memory or any other suitable level of granularity.

The selection of the diagnostic mode of the application can be done in any suitable manner. For example, the application can simply be invoked using any appropriate command line switch to cause the application to execute in such diagnostic mode. Additionally, the application can be configured by the developer to respond to a particular user input or code to switch to a diagnostic mode at any suitable time during application execution.

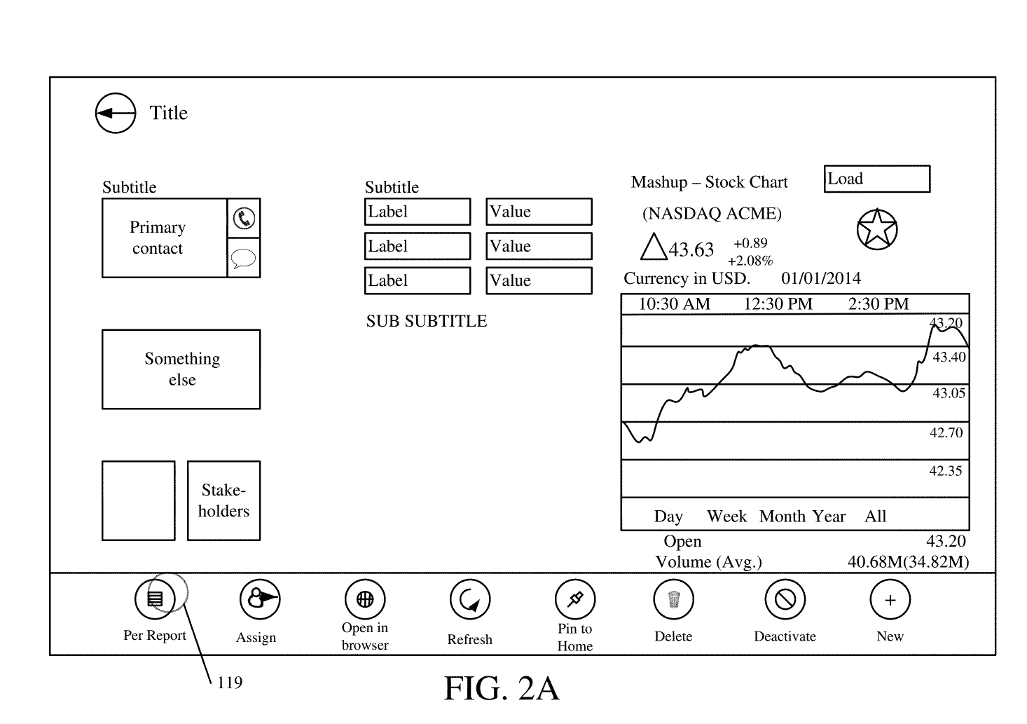

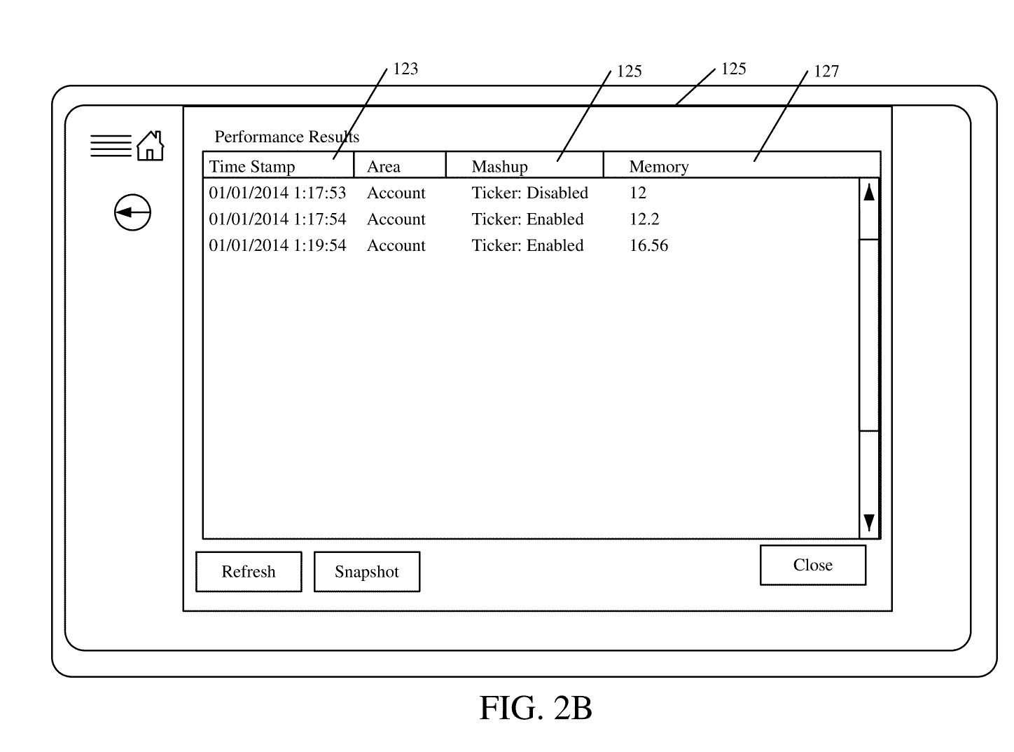

FIGS. 2A and 2B are examples of user interfaces on a mobile device in accordance with embodiments described herein. As shown in FIG. 2A, a user interface element 119 can be provided that, when actuated by a user or developer, can cause the mobile device to display performance results, such as those indicated with respect to FIG. 2B. The provision of performance results can take any suitable form, but, in one embodiment, are provided as shown on display 121 in FIG. 2B. As can be seen, timestamp information 123 information is stored along with mashup information 125 and memory information 127.

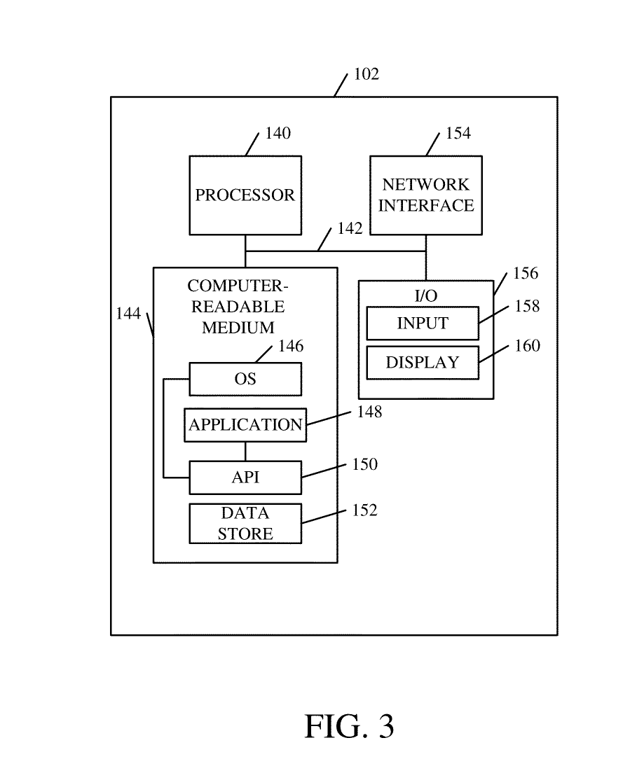

FIG. 3 is diagrammatic view of mobile device 102 with which embodiments described herein are particularly useful. Mobile device 102 includes processor 140, which can be a microprocessor having one or more individual cores. Processor 140 is coupled to system bus 142 that communicatively couples various components within mobile device 102. Computer readable medium 144 is coupled to system bus 142 and has instructions stored therein, which, when executed by processor 140, cause processor 140 to provide a number of functions. In particular, instructions stored within computer readable medium 144 provide, when executed by processor 140, operating system 146, one or more executable applications 148, application programming interface (API) 150, and data store 152.

Computer readable medium 144 can be any suitable type of computer readable medium that is able to persistently store data. Additionally, at least some of computer readable medium 144 may also include volatile computer readable medium such as random access memory (RAM). Further, processor 140 may have its own operating memory in order to execute one or more applications 148. Operating system 146 can be any suitable mobile operating system that is now known or later developed. Operating system 146, in one example, includes an application programming interface 150 that allows applications executing on mobile device 102 to obtain memory usage information. Such memory usage information can be any suitable information regarding the utilization of any memory within the mobile device. Accordingly, memory usage information includes the utilization of non-volatile system memory, the utilization of volatile operating system memory, the error rate detected with respect to either type of memory, or any other suitable parameters.

As illustrated in FIG. 3, mobile device 102 includes network interface 154 coupled to system bus 142. Network interface 154 allows mobile device 102 to communicate with one or more external devices via a communication network, such as a cellular communication network, and/or a Wi-Fi communication network. Further, mobile device 102 also includes I/O module 156 that is configured to interact with one or more inputs 158 and provide a display output 160 to a user.

In accordance with embodiments described herein, application 148 executing on mobile device 102 is caused, in one way or another, to enter a diagnostic mode, in which execution of application 148 occurs until a predefined checkpoint within the application lifecycle is encountered. At such predefined checkpoint, application 148 interacts with API 150 to obtain a memory snapshot relative to memory utilization within mobile device 102. This memory snapshot is saved within data store 152 and can optionally be presented to a user or developer of application 148 via display 160. In the event that multiple memory snapshots are saved in data store 152, the visual indication provided to the user or developer of application 148 via display 160 can also include a graph or other suitable display showing memory usage referenced to the application lifecycle and/or referenced to time. Suitable checkpoints in the application lifecycle for application 148 can include, for example, obtaining a snapshot when a Form_Load operation is initiated, obtaining another memory snapshot when the Form_Load operation is complete. Still another suitable checkpoint includes obtaining a memory snapshot when a Mashup_Load operation is initiated, and still another memory snapshot when a Mashup_Load operation is completed. In this way, if any particular form or mashup consumes a disproportionate amount of system operating memory, or even a momentary spike in system operating memory consumption, such condition can be detected and a developer of application 148 can revise application 148 in order to address the problem.

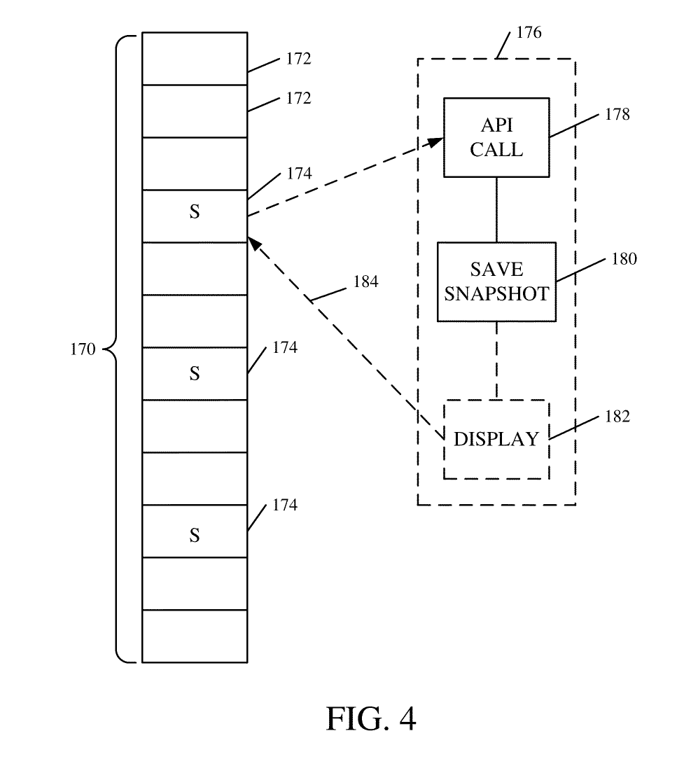

FIG. 4 is a diagrammatic view of an application lifecycle 170 having a number of programmatic elements or steps 172 as well as a plurality of checkpoints 174 in which memory snapshots are obtained. Programmatic elements 172 may be particular modules or routines executed during operation of application 148, or they may be individual steps sequenced through during the execution of application 148. Regardless, a developer of application 148 has provided a number of checkpoints 174 which, when encountered during execution of application 148, cause a snapshot 176 to be obtained. As illustrated in FIG. 4, the snapshot generally employs an API, such as API 150 (shown in FIG. 3) of operating system 146, in order to obtain memory utilization information, as indicated at block 178. Once the memory utilization information is obtained, the memory utilization is saved in a data store, such as data store 152, as indicated at block 180. Optionally, the memory utilization information can be displayed or otherwise indicated to the user of mobile device 102, as indicated at block 182. Once snapshot 176 is complete, control returns to the application execution as indicated by phantom line 184.

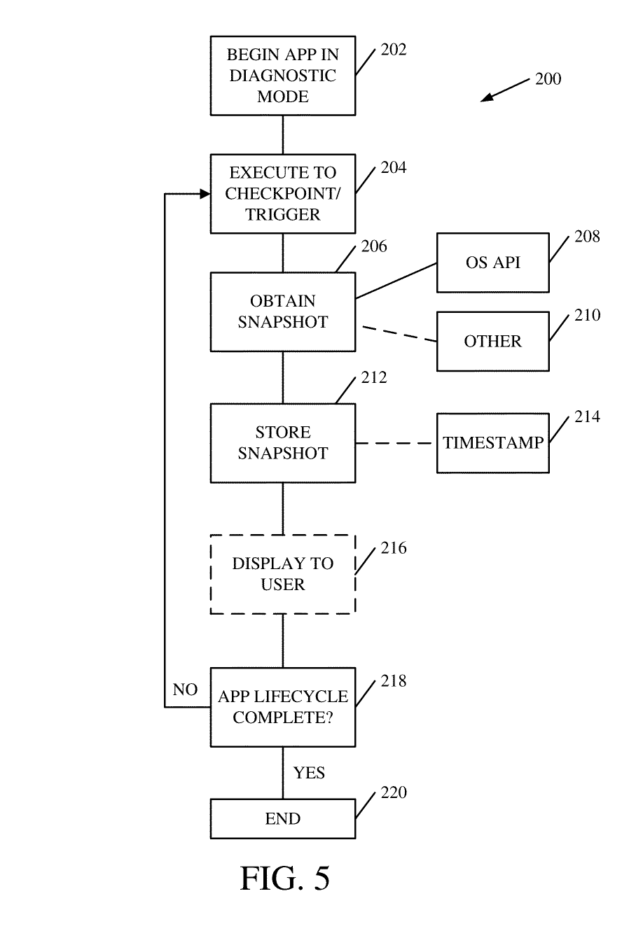

FIG. 5 is a flow diagram of a method of executing a mobile device application in accordance with one embodiment. Method 200 begins at block 202 where an application is initiated, or otherwise set into a diagnostic mode. In this mode, the application will automatically, or in response to a user input, obtain memory snapshot information when individual checkpoints within the programmatic execution are encountered, or in response to a user input. It is generally preferred that the diagnostic mode be selectable such that when the application operates in a non-diagnostic mode it is allowed to run more efficiently. When executing in the diagnostic mode, the application will execute on the mobile device, such as mobile device 102 until a predefined checkpoint or user-initiated trigger is encountered, as indicated at block 204. When this occurs, method 200 passes to block 206 where a memory snapshot is obtained. This memory snapshot can be obtained by causing the application to interact with an API of the operating system, as indicated at block 208, or any other suitable method, as indicated at block 210. Other suitable methods may include, the application specifically querying individual operating system and/or hardware resources directly, without using any available APIs. This may be useful for operating systems that may not provide a convenient way in which to obtain memory snapshot information or in situations where the available memory utilization information from the API of the operating system does not provide all required memory utilization information. Further still, snapshot 206 can include utilization of an API of the operating system in addition to other techniques for determining further information relative to memory utilization.

Once the memory utilization snapshot is obtained, control passes to block 212 where the snapshot information is stored. As indicated at block 214, this snapshot information is preferably stored with a timestamp and/or an indication of the checkpoint that generated the snapshot. For example, if the checkpoint is a Mashup_Load operation, the stored snapshot information can indicate the memory utilization information; the Mashup_Load operation; and/or a timestamp, as appropriate. Next, at phantom box 216, the snapshot information may be optionally displayed to a user, such as a user of mobile device 102, or any other suitable party. For example, it is contemplated that the snapshot information could also be conveyed to a remote party for analysis in order to improve the application. Next, at block 218, method 200 determines whether the application lifecycle is complete. If so, control passes to block 220 where method 200 ends. If not, control returns to block 204 where method 200 waits for programmatic operation to encounter the next checkpoint or user input requesting acquisition of snapshot information.

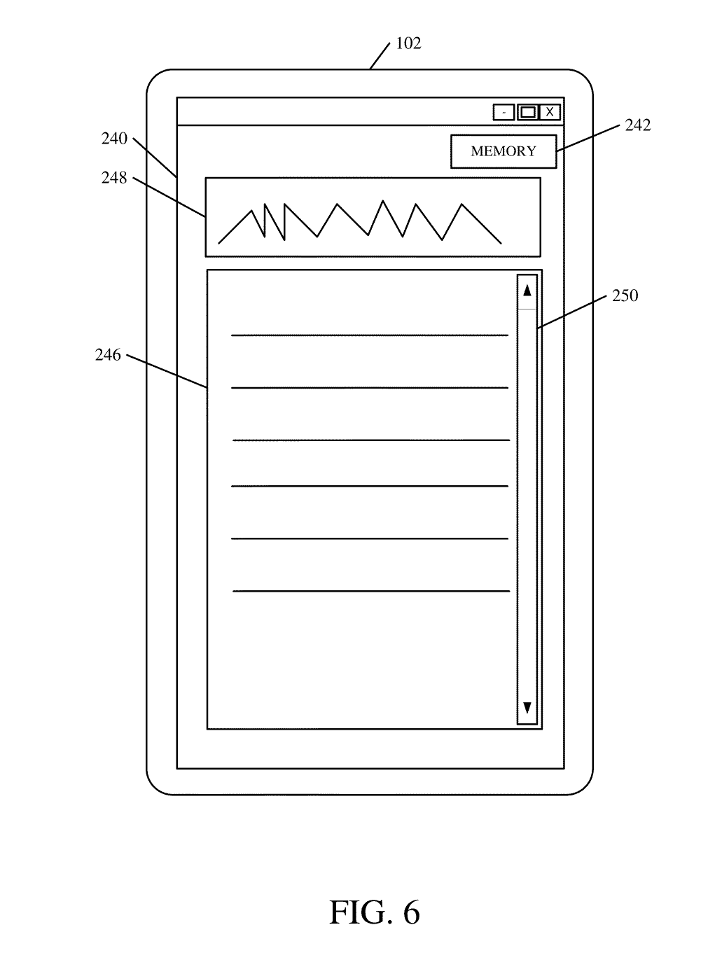

FIG. 6 is a diagrammatic view of mobile device 102 having a user interface display 240. Display 240 has a user-selectable element 242 that allows a user thereof to manually cause the application to obtain a memory snapshot. Accordingly, when element 242 is displayed to a user, snapshots can be obtained any time a user engages user interface element 242. Memory utilization information is displayed, by display 240, as indicated at panes 246 and 248. Pane 246 indicates any suitable textual information regarding one or more pages of memory and utilization thereof when a snapshot was acquired. Additionally, pane 246 may include a scrollbar 250 to allow the user to view a substantial amount of textual information, which is significantly more than would conveniently fit on the screen of mobile device 102. Additionally, a chart showing snapshot information referenced to the application lifecycle and/or time is provided in pane 248. Accordingly, a user can conveniently determine whether particular application lifecycle events, such as a particular form load operation, generates disproportionate spikes or utilization of operating system memory. Thus, users of an application provided in accordance of embodiments herein will receive significant insights as to key lifecycle events of the application.

Understanding the cause of conditions that affect application performance is very important and is made more difficult by the various modules and operations that run substantially simultaneously on a mobile device when a mashup application is executed. Providing an effective way to identify various programmatic operations that occur during an application's lifecycle via the acquisition of one or more memory snapshots allows users and/or developers to more quickly improve application performance. Further, since application performance may vary depending on the particular mobile device hardware/software platform that is executing the application, providing an expeditious way to identify causes of performance issues helps application developers port or otherwise design their applications for a variety of platforms more effectively and/or quickly.

A number of user interface displays have been discussed. They can take a wide variety of different forms and can have a wide variety of different user actuatable input mechanisms disposed thereon. For instance, the user actuatable input mechanisms can be text boxes, check boxes, icons, links, drop-down menus, search boxes, etc. They can also be actuated in a wide variety of different ways. For instance, they can be actuated using a point and click device (such as a track ball or mouse). They can be actuated using hardware buttons, switches, a joystick or keyboard, thumb switches or thumb pads, etc. They can also be actuated using a virtual keyboard or other virtual actuators. In addition, where the screen on which they are displayed is a touch sensitive screen, they can be actuated using touch gestures. Also, where the device that displays them has speech recognition components, they can be actuated using speech commands.

Also, the figures show a number of blocks with functionality ascribed to each block. It will be noted that fewer blocks can be used so the functionality is performed by fewer components. Also, more blocks can be used with the functionality distributed among more components.

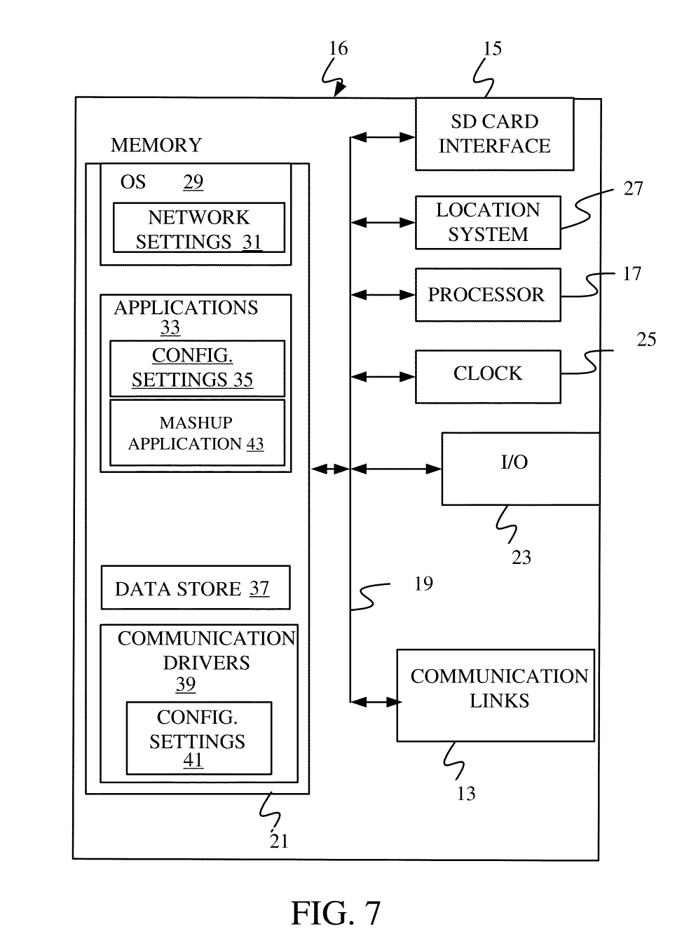

FIG. 7 provides a general block diagram of the components of mobile device 16 that can execute one or more applications in accordance with one embodiment. In the device 16, a communications link 13 is provided that allows the mobile device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems are received on a removable Secure Digital (SD) card that is connected to a SD card interface 15. SD card interface 15 and communication links 13 communicate with a processor 17 along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. Memory 21 stores computer readable instructions that, when executed by processor 17, cause the processor to perform computer-implemented steps or functions according to the instructions. Application 148 (shown in FIG. 3) or the items in data store 152, for example, can reside in memory 21. Applications 33 can include mashup application 43.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

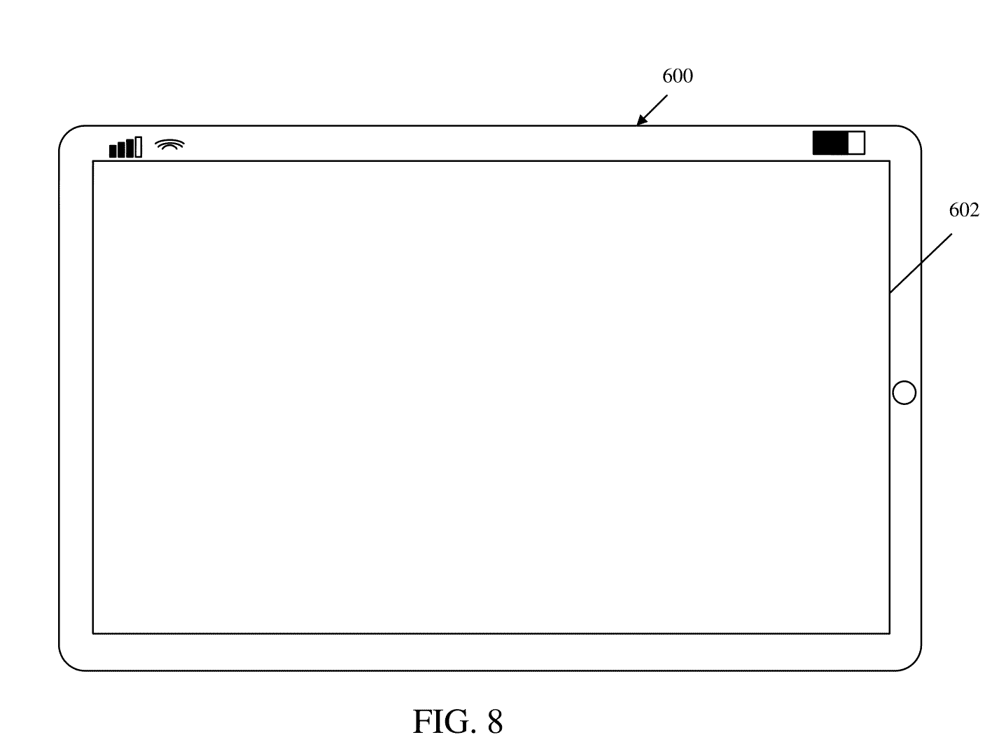

FIG. 8 shows one embodiment in which device 16 is a tablet computer 600. In FIG. 8, computer 600 is shown with display screen 602. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

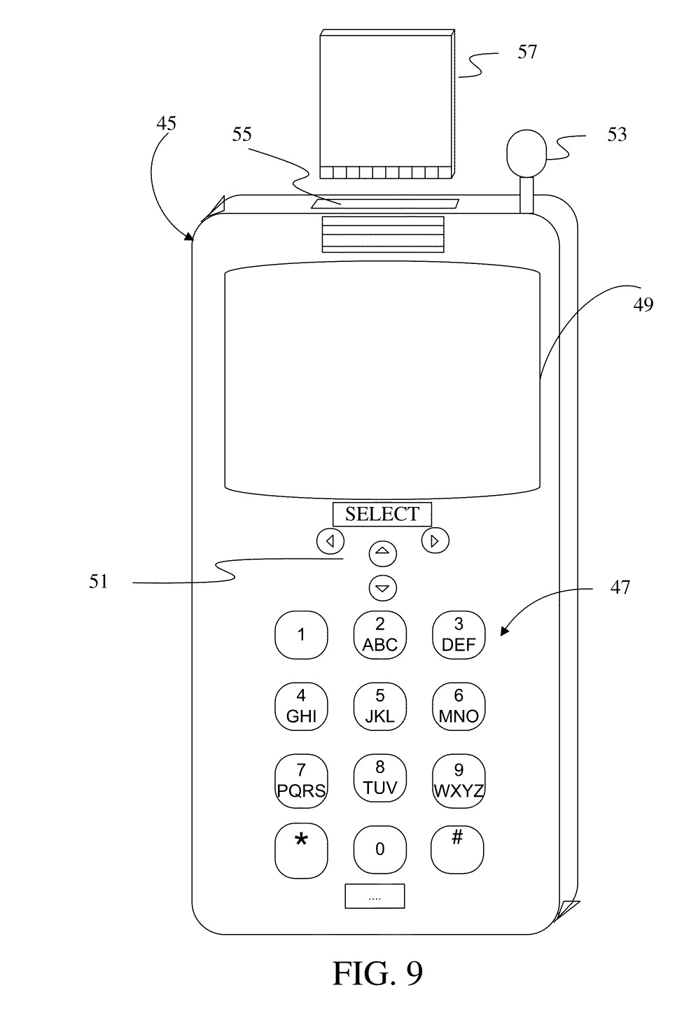

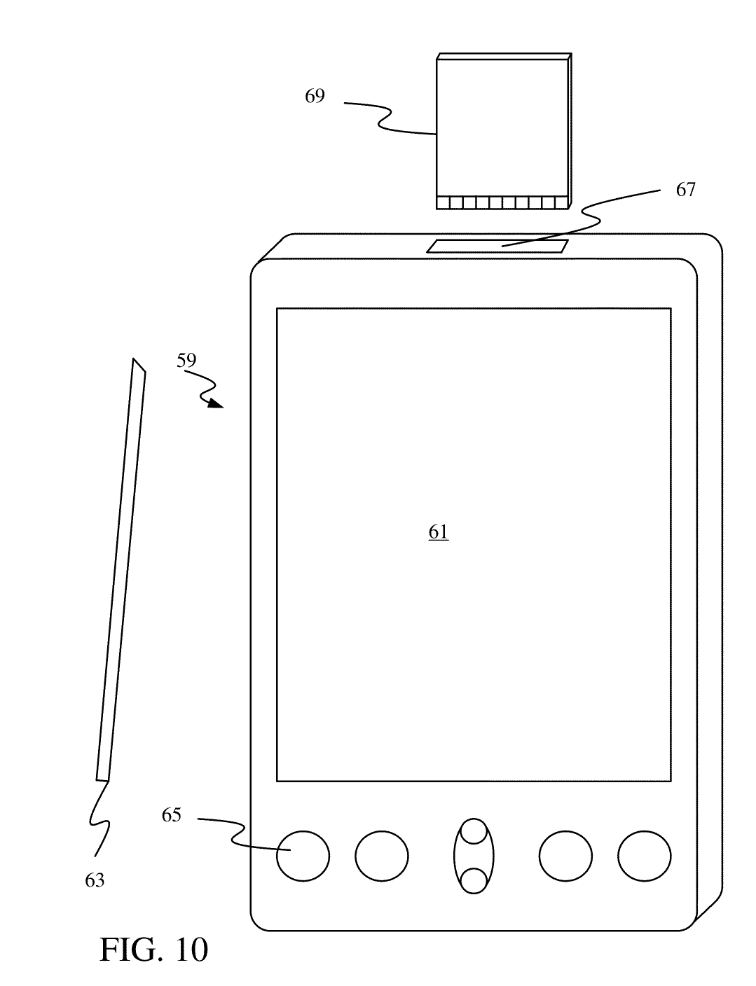

FIGS. 9 and 10 provide additional examples of devices 16 that can be used, although others can be used as well. In FIG. 9, a feature phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1×rtt, and Short Message Service (SMS) signals. In some embodiments, phone 45 also includes a Secure Digital (SD) card slot 55 that accepts a SD card 57.

The mobile device of FIG. 10 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

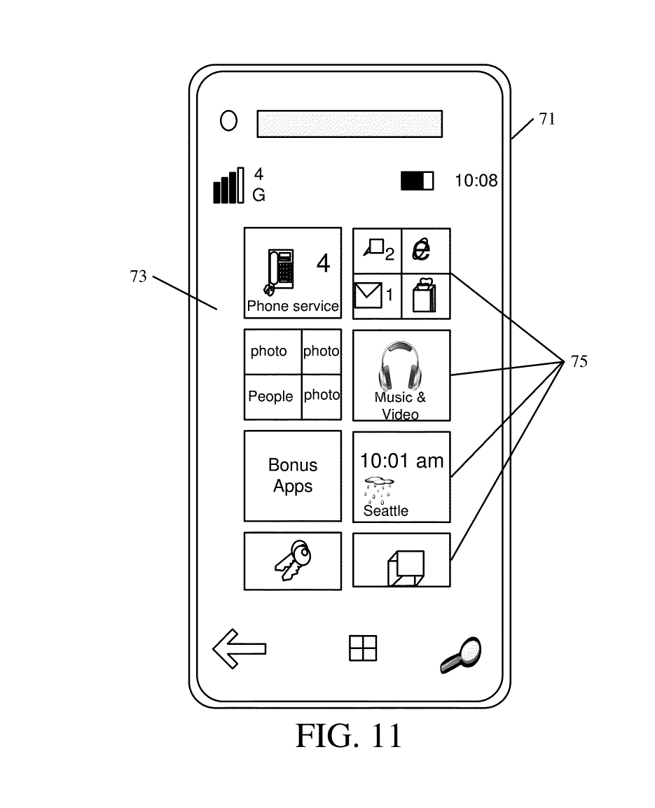

FIG. 11 is similar to FIG. 9 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), et cetera.

It should also be noted that the different embodiments described herein can be combined in different ways. That is, parts of one or more embodiments can be combined with parts of one or more other embodiments. All of this is contemplated herein.

Example 1 is a mobile device that includes a processor and computer-readable memory having instructions stored thereon that, when executed by the processor, provide an application. The application obtains and stores snapshot information regarding consumption of the computer-readable memory of the mobile device, upon the occurrence of one or more predefined conditions.

Example 2 is the mobile device of any or all previous examples wherein the one or more predefined conditions includes a predefined checkpoint in the application.

Example 3 is the mobile device of any or all previous examples wherein the predefined checkpoint is a form loading operation.

Example 4 is the mobile device of any or all previous examples wherein the predefined checkpoint is a resource loading operation.

Example 5 is the mobile device of any or all previous examples wherein the predefined checkpoint includes navigation away from a resource.

Example 6 is the mobile device of any or all previous examples wherein the application is a hybrid application.

Example 7 is the mobile device of any or all previous examples wherein the application is a mashup application operably coupled to a plurality of data sources external to the mobile device.

Example 8 is the mobile device of any or all previous examples wherein the application is configured to authenticate with at least one data source.

Example 9 is the mobile device of any or all previous examples wherein the application is configured to communicate using encryption.

Example 10 is the mobile device of any or all previous examples wherein the application includes a diagnostic mode where snapshot information is obtained and stored upon the occurrence of one or more predefined conditions and another mode in which snapshot information is not obtained upon the occurrence of one or more predefined conditions.

Example 11 is the mobile device of any or all previous examples wherein selection of the diagnostic mode is provided by the application in response to a predefined user input during application execution.

Example 12 is the mobile device of any or all previous examples wherein selection of the diagnostic mode is provided by a command line switch.

Example 13 is the mobile device of any or all previous examples wherein the one or more predefined conditions includes the occurrence of an operating system message.

Example 14 is the mobile device of any or all previous examples wherein the operating system message includes a low memory warning.

Example 15 is the mobile device of any or all previous examples wherein the mobile device is configured to provide the snapshot information to a developer.

Example 16 is the mobile device of any or all previous examples wherein the application is configured to obtain the snapshot information using an application programming interface of the mobile device.

Example 17 is a computer-implemented method of executing an application on a mobile device. The computer-implemented method includes receiving a mode selection signal and detecting a predefined checkpoint during execution of the application. Snapshot information is obtained relative to memory consumption associated with the application. The snapshot information is stored on a mobile device.

Example 18 is the computer-implemented method of any or all previous examples wherein the snapshot information is broken down to individual pages of memory.

Example 19 is the computer-implemented method of any or all previous examples wherein the snapshot information is displayed graphically on the mobile device.

Example 20 is a mobile device that includes a display, a processor, and a network interface coupled to the processor and configured to communicate with a plurality of data sources. The mobile device also includes computer-readable memory having instructions stored therein that, when executed by the processor, provide an application that displays information on the display relative to the plurality of data sources. The application includes at least one predefined checkpoint that, when reached during programmatic execution, causes the processor to obtain and store snapshot information regarding consumption of the computer-readable memory of the mobile device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A mobile device comprising:
a processor;
computer-readable memory having instructions stored thereon that, when executed by the processor, provide an application that obtains and stores snapshot information regarding consumption of the computer-readable memory of the mobile device, upon the occurrence of one or more predefined conditions.

2. The mobile device of claim 1, wherein the one or more predefined conditions includes a predefined checkpoint in the application.

3. The mobile device of claim 2, wherein the predefined checkpoint is a form loading operation.

4. The mobile device of claim 2, wherein the predefined checkpoint is a resource loading operation.

5. The mobile device of claim 2, wherein the predefined checkpoint includes navigation away from a resource.

6. The mobile device of claim 1, wherein the application is a hybrid application.

7. The mobile device of claim 1, wherein the application is a mashup application operably coupled to a plurality of data sources external to the mobile device.

8. The mobile device of claim 7, wherein the application is configured to authenticate with at least one data source.

9. The mobile device of claim 8, wherein the application is configured to communicate using encryption.

10. The mobile device of claim 1, wherein the application includes a diagnostic mode where snapshot information is obtained and stored upon the occurrence of one or more predefined conditions and another mode in which snapshot information is not obtained upon the occurrence of one or more predefined conditions.

11. The mobile device of claim 10, wherein selection of the diagnostic mode is provided by the application in response to a predefined user input during application execution.

12. The mobile device of claim 10, wherein selection of the diagnostic mode is provided by a command line switch.

13. The mobile device of claim 1, wherein the one or more predefined conditions includes the occurrence of an operating system message.

14. The mobile device of claim 13, wherein the operating system message includes a low memory warning.

15. The mobile device of claim 1, wherein the mobile device is configured to provide the snapshot information to a developer.

16. The mobile device of claim 1, wherein the application is configured to obtain the snapshot information using an application programming interface of the mobile device.

17. A computer-implemented method of executing an application on a mobile device, the method comprising:
receiving a mode selection signal;
detecting a predefined checkpoint during execution of the application;
obtaining snapshot information relative to memory consumption associated with the application; and
storing the snapshot information on a mobile device.

18. The computer-implemented method of claim 17, wherein the snapshot information is broken down to individual pages of memory.

19. The computer-implemented method of claim 17, wherein the snapshot information is displayed graphically on the mobile device.

20. A mobile device comprising:
a display;
a processor;
a network interface coupled to the processor and configured to communicate with a plurality of data sources;
computer-readable memory having instructions stored therein that, when executed by the processor, provide an application that displays information on the display relative to the plurality of data sources; and
wherein the application includes at least one predefined checkpoint that, when reached during programmatic execution, causes the processor to obtain and store snapshot information regarding consumption of the computer-readable memory of the mobile device.
